(19) United States
(12) Patent Application Publication
(10) Pub. No.: US 2005/0276527 A1
(43) Pub. Date: Dec. 15, 2005

(54) Spindle motor

(75) Inventors: Jin-gyoo Yoo, Seongnam-si (KR); Gun-hee Jang, Seoul (KR); Cheol-soon Kim, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/149,366

(22) Filed: Jun. 10, 2005

(30) Foreign Application Priority Data
Jun. 11, 2004 (KR) 10-2004-0042919

(51) Int. Cl. F16C 32/06

(52) U.S. Cl. 384/100

(57) ABSTRACT

Provided is a spindle motor which includes a base, a sleeve fixed on the base and having a hollow portion, and a shaft rotatably installed in the hollow portion of the sleeve. In the spindle motor, a plurality of journal grooves are formed in an outer circumferential surface of the shaft to form a journal bearing which supports the shaft in a radial direction when the shaft rotates, and the journal grooves are arranged at an uneven interval.

### CROSS-REFERENCE TO RELATED APPLICATION

This application claims the priority of Korean Patent Application No. 10-2004-0042919, filed on Jun. 11, 2004, in the Korean Intellectual Property Office, the disclosure of which is incorporated herein in its entirety by reference.

### BACKGROUND OF THE INVENTION

1. Field of the Invention

The present invention relates to a spindle motor, and more particularly, to a spindle motor having improved stiffness and damping performance of a bearing.

2. Description of the Related Art

In general, a spindle motor is widely used for a laser beam scanner for a laser printer, a hard disk drive (HDD), an optical disc drive such as a compact disc (CD) drive or a digital versatile disk (DVD) drive. Since the spindle motor used in the HDD requires high rotational precision, a hydrodynamic bearing having high rotational precision is generally being used.

FIG. 1 shows a conventional spindle motor for an HDD using a hydrodynamic bearing. Referring to FIG. 1, the conventional spindle motor for an HDD includes a base 10, a sleeve 12, a shaft 20, and a hub 24. A coil 14 is provided at both sides of the base 10. The sleeve 12 is fixed on the base 10 and has a hollow portion at the center portion thereof. The shaft 20 is rotatably installed in the hollow portion of the sleeve 12. A bearing clearance to prevent friction with the sleeve 12 during the rotation of the shaft 20 is formed between the shaft 20 and the sleeve 12. The bearing clearance is filled with lubricating fluid.

The hub 24 on which a disc is placed is coupled to an upper portion of the shaft 20. A magnet 26 corresponding to the coil 14 is provided at the opposite sides of a lower portion of the hub 24. The coil 14 and the magnet 26 generate an electromagnetic force by an interaction therebetween to rotate the shaft 20. A thrust flange 40 is provided at the lower portion of the shaft 20 to prevent the shaft 20 from escaping from the sleeve 12. A bearing clearance is formed between the thrust flange 40 and the sleeve 12 and filled with lubricating fluid.

A rotation portion of the spindle motor configures as above is supported in a radial direction by upper and lower journal bearings 31 and 32 formed at the upper and lower portions of the shaft 20, and in an axial direction by upper and lower thrust bearings 41 and 42 formed at the upper and lower portions of thrust flange 40.

FIG. 2 is a cross-sectional view of the shaft 20 and the sleeve 12 forming the upper journal bearing 31 of the spindle motor shown in FIG. 1. FIG. 3 is a development view of a groove pattern formed on the outer circumferential surface of the shaft 20 shown in FIG. 2.

Referring to FIGS. 2 and 3, a plurality of groves 21 are formed in a herringbone format on an upper portion of the outer circumferential surface of the shaft 20 that forms the upper journal bearing 31. The grooves 21 are formed at a constant interval. A plurality of grooves 22 are formed in a herringbone format at a constant interval, as shown in FIG. 1, on a lower portion of the outer circumferential surface of the shaft 20 that forms the lower journal bearing 32. Although not shown in the drawings, a plurality of grooves are formed at a constant interval on the upper and lower surfaces of the thrust flange 40 forming the upper and lower thrust bearings 41 and 42.

For a hydrodynamic bearing, stiffness and damping performance thereof are improved as the eccentricity ratio of a rotation body increases. However, in a spindle motor for a hard disk drive in which unbalance in the weight of the rotation body is small and no external force applied to the rotation body exists, when the conventional journal bearings 31 and 32 having the grooves 21 and 22 which are distributed at a constant interval on the outer circumferential surface of the shaft 20 are used, the eccentricity ratio of the rotation body becomes very small so that it is difficult to increase the stiffness of the journal bearings 31 and 32. If a bearing having a great stiffness at the same rotation speed is to be designed using the conventional journal bearing, a method of increasing the size of the bearing may be available. In this case, however, a frictional torque increases, efficiency during starting and driving the motor remarkably decreases.

### SUMMARY OF THE INVENTION

To solve the above and/or other problems, the present invention provides a spindle motor for a hard disk drive in which stiffness and damping performance of a bearing are improved by increasing the eccentricity ratio of the rotation body without affecting a frictional torque.

According to an aspect of the present invention, a spindle motor includes a base, a sleeve fixed on the base and having a hollow portion, and a shaft rotatably installed in the hollow portion of the sleeve, wherein a plurality of journal grooves are formed in an outer circumferential surface of the shaft to form a journal bearing which supports the shaft in a radial direction when the shaft rotates, and the journal grooves are arranged at an uneven interval.

According to another aspect of the present invention, a spindle motor comprises a base, a sleeve fixed on the base and having a hollow portion, and a shaft rotatably installed in the hollow portion of the sleeve, wherein a plurality of journal grooves are formed in an inner circumferential surface of the sleeve corresponding to an outer circumferential surface of the shaft to form a journal bearing which supports the shaft in a radial direction when the shaft rotates, and the journal grooves are arranged at an uneven interval.

### BRIEF DESCRIPTION OF THE DRAWINGS

Features of the present invention will become more apparent by describing in detail exemplary embodiments thereof with reference to the attached drawings in which:

FIG. 1 is a cross sectional view of a conventional spindle motor for a hard disk drive using a hydrodynamic bearing;

FIG. 2 is a cross-sectional view of the shaft and the sleeve forming the journal bearing of the spindle motor shown in FIG. 1;

FIG. 3 is a development view of a groove pattern formed on the outer circumferential surface of the shaft shown in FIG. 2;

FIG. 4 is a cross-sectional view of a spindle motor for a hard disk drive according to an exemplary embodiment of the present invention;

FIG. 5 is a cross-sectional view of the shaft and the sleeve forming the journal bearing of the spindle motor shown in FIG. 4;

FIG. 6 is a development view of a groove pattern formed on the outer circumferential surface of the shaft shown in FIG. 5;

FIG. 7 is a development view of a modified example of a groove pattern formed on the outer circumferential surface of the shaft shown in FIG. 5;

FIG. 8 is a cross-sectional view of the thrust flange according to an exemplary embodiment of the present invention;

FIG. 9 is a cross-sectional view of the shaft and the sleeve forming a journal bearing of a spindle motor for a hard disk drive according to another exemplary embodiment of the present invention; and

FIG. 10 is a graph showing the trajectory of the center of mass of each of the spindle motor A for a hard disk drive using a conventional journal bearing and the spindle motor B for a hard disk drive using a journal bearing according to the exemplary embodiment of the present invention.

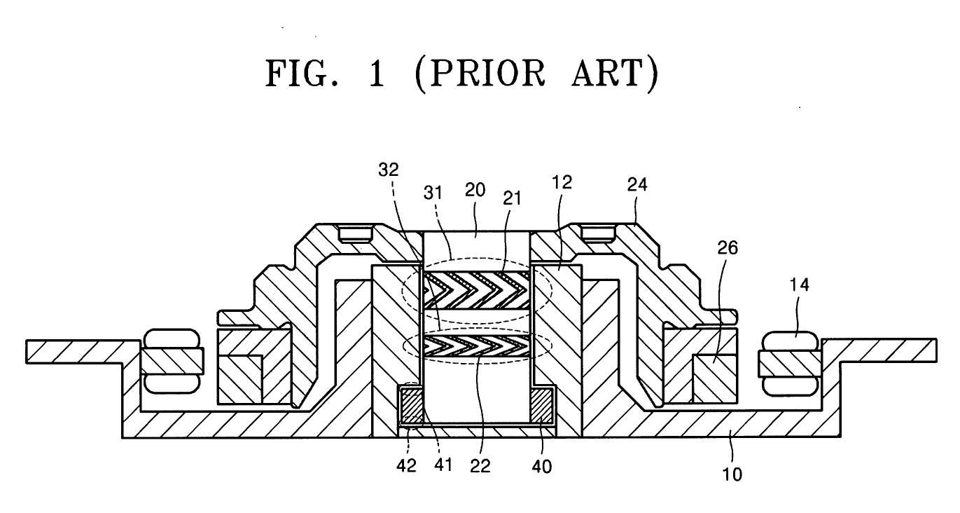

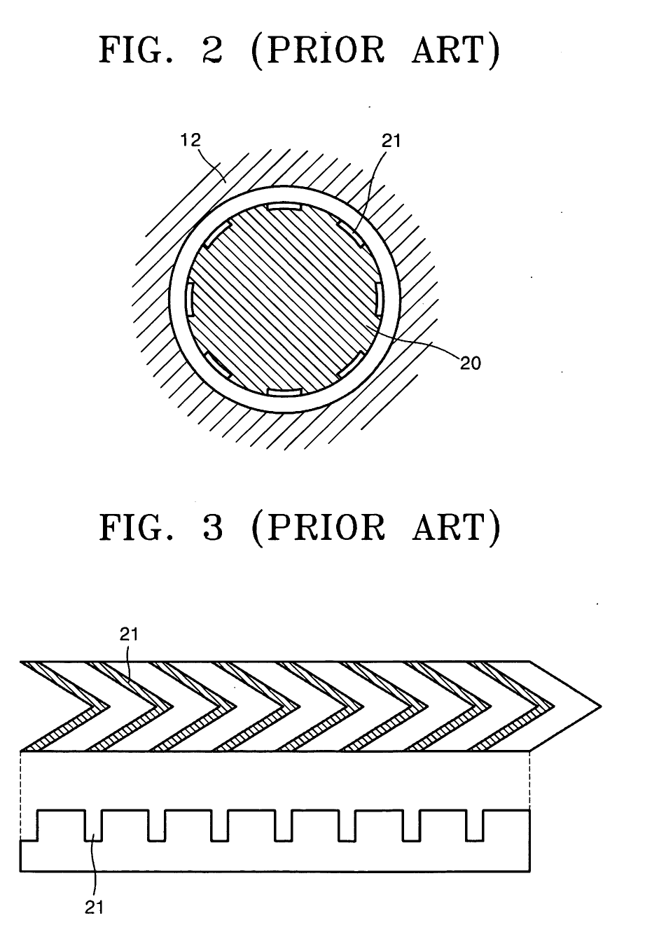

### DETAILED DESCRIPTION OF THE EXEMPLARY EMBODIMENTS

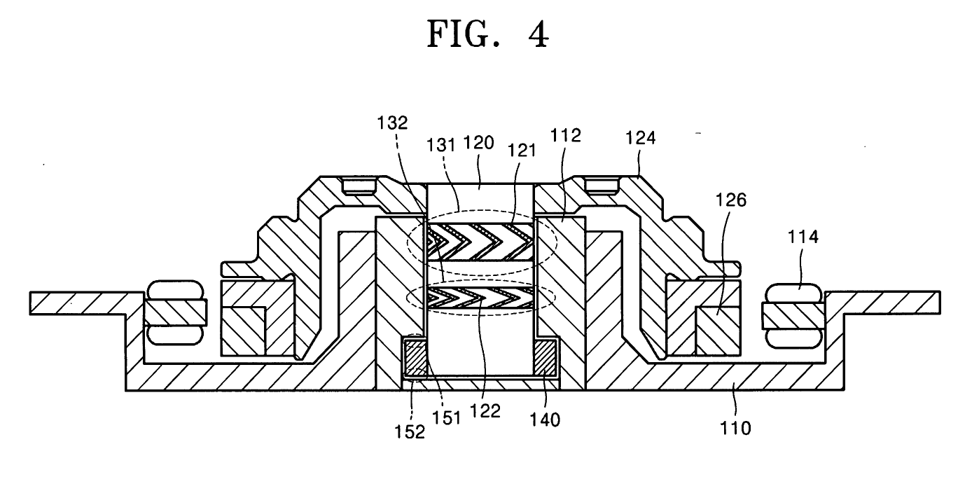

In the drawings, the same reference numerals indicate the same constituent elements. FIG. 4 illustrates a spindle motor for a hard disk drive adopting a hydrodynamic bearing according to an exemplary embodiment of the present invention Referring to FIG. 4, a spindle motor for a hard disk drive according to an embodiment of the present invention includes a base 110, a sleeve 112, and a shaft 120. A coil 114 is provided at both sides of the base 110. The sleeve 112 is fixed on the base 110 and a hollow portion is formed in a center portion of the sleeve 112. The shaft 120 is rotatably installed in the hollow portion. A bearing clearance to prevent friction with the sleeve 112 during rotation of the shaft 120 is formed between the shaft 120 and the sleeve 112. The bearing clearance is filled with lubricating fluid. The lubricating fluid separates the shaft 120 from the sleeve 112 so that the shaft 120 can rotate without contacting the sleeve 112. As a result, non-repeatable runout (NRRO) badly affecting recording/reproduction of a hard disk is not generated. In the present exemplary embodiment, air can be used as the lubricating fluid. When the air having a low viscosity is used as the lubricating fluid, frictional loss can be reduced and a change in the characteristic of a bearing due to friction heat can be reduced.

The shaft 120 can be formed of ceramic such as alumina or zirconia. This material can provide antifriction and anti-shock features to the spindle motor. The sleeve 112 can be formed of ceramic like the shaft 120.

A hub 124 on which a disc is placed is coupled to an upper portion of the shaft 120. A magnet 126 corresponding to the coil 114 is provided at the opposite sides of a lower portion of the hub 124. The coil 114 and the magnet 126 generate an electromagnetic force by an interaction therebetween to rotate the shaft 120. A thrust flange 140 having an outer diameter greater than that of the shaft 120 is provided at the lower portion of the shaft 120 to prevent the shaft 120 from escaping from the sleeve 112. A bearing clearance is formed between the thrust flange 140 and the sleeve 112 and filled with lubricating fluid.

In the spindle motor for a hard disk drive configured as above, a journal bearing supporting the shaft 120 in a radial direction is formed between the shaft 120 and the sleeve 112 and a thrust bearing supporting the shaft 120 in the axial direction is formed between the thrust flange 140 and the sleeve 112. The journal bearing includes upper and lower journal bearings 131 and 132 formed at the upper and lower portions of the shaft 120.

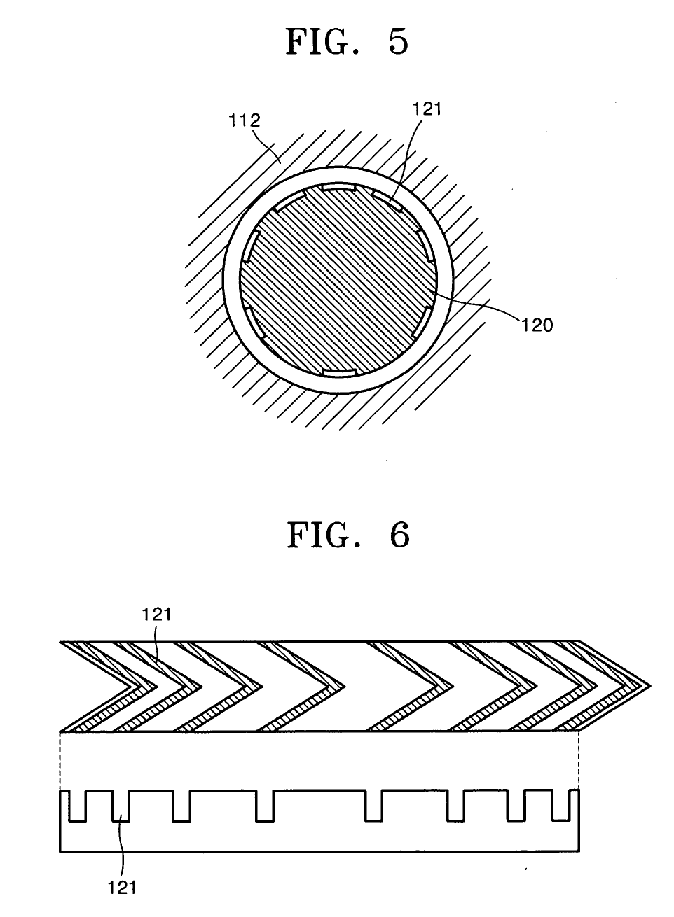

FIG. 5 is a cross-sectional view of the shaft 120 and the sleeve 112 forming the journal bearing 131 of the spindle motor shown in FIG. 4. FIG. 6 is a development view of a groove pattern formed on the outer circumferential surface of the shaft 120 shown in FIG. 5.

Referring to FIGS. 5 and 6, a plurality of upper journal grooves 121 for generating hydrodynamic pressure in the radial direction of the shaft 120, which form the upper journal bearing 131, are formed in a herringbone shape at the upper portion of the outer circumferential surface of the shaft 120. When the upper journal grooves 121 are formed in a herringbone shape, a large amount of load capacity and stiffness can be obtained in the radial direction of the shaft 120 by a pumping effect of the fluid, as well as rotation stability.

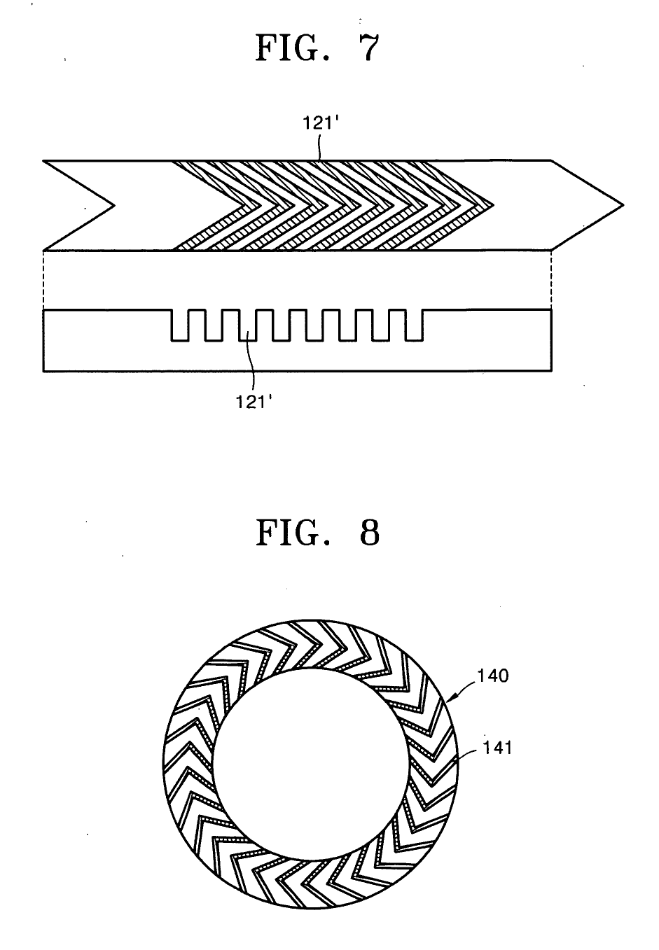

In the present exemplary embodiment, the upper journal grooves 121 are arranged at an uneven interval at the upper portion of the outer circumferential surface of the shaft 120, unlike the grooves in the conventional technology. By arranging the upper journal grooves 121 at an uneven interval, pressure in the hydrodynamic bearing is asymmetrically formed with respect to the center of the shaft 120. That is, as the shaft 120 rotates, in the hydrodynamic bearing, a relatively large pressure is generated at a portion where the interval between the upper journal grooves 121 is large. This is because the thickness of an oil film decreases at the portion where the interval between the upper journal grooves 121 is relatively large. Likewise, when the distribution of pressure in the hydrodynamic bearing is asymmetrical, the center of rotation of the shaft 120 is moved to a position where a bearing force and an inertial force are balanced and rotates with eccentricity. Accordingly, the stiffness of the upper journal bearing 131 increases. FIG. 7 illustrates a modified example of the groove pattern formed on the upper portion of the outer circumferential surface of the shaft 120, in which upper grooves 121′ are formed at a predetermined portion of the outer circumferential surface of the shaft 120.

A plurality of lower journal grooves 122 are formed in a herring bone shape at the lower portion of the outer circumferential surface of the shaft 120 to form the lower journal bearing 132 as shown in FIG. 4. The lower journal grooves 122 are arranged at the lower portion of the outer circumferential surface of the shaft 120 at an uneven interval to increase the eccentricity ratio like the upper journal grooves 121.

Although in the above descriptions a case having two journal bearings 131 and 132 is explained, the spindle motor according to the present embodiment is not limited thereto and one journal bearing or three or more journal bearings can be provided.

The thrust bearing includes upper and lower thrust bearings 151 and 152 formed at the upper and lower portions of the thrust flange 140, respectively. FIG. 8 shows the upper surface of the thrust flange 140.

Referring to FIG. 8, a plurality of grooves 141 forming a hydrodynamic pressure in the axial direction of the shaft 120 are formed on the upper surface of the thrust flange 140 in a herringbone shape to form the upper thrust bearing 151 of FIG. 4. The thrust grooves 141 are arranged at a constant interval. A plurality of grooves 141 are formed on the lower surface of the thrust flange 140 in a herringbone shape to form the lower thrust bearing 152 of FIG. 4. By forming the thrust grooves 141 on the upper and lower surfaces of the thrust flange 140 in a herringbone shape, a large load support capacity and stiffness in the axial direction of the shaft 120 can be obtained.

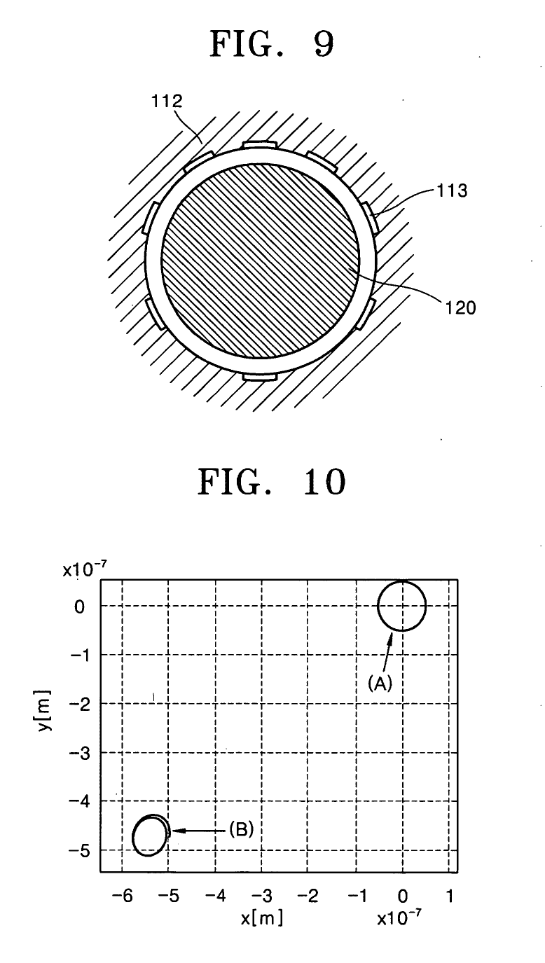

FIG. 9 is a cross-sectional view of the shaft and the sleeve forming a journal bearing of a spindle motor for a hard disk drive according to another exemplary embodiment of the present invention. Here, only features different from those of the above-described exemplary embodiment are described below.

Referring to FIG. 9, unlike the above exemplary embodiment, in the present exemplary embodiment, to form the upper journal bearing 131 of FIG. 4, a plurality of upper journal grooves 113 in a herringbone shape are formed at the upper portion of the inner circumferential surface of the sleeve 112 corresponding to the outer circumferential surface of the shaft 120. The upper journal grooves 113 are arranged at an uneven interval and accordingly the shaft 120 rotates with eccentricity. A plurality of lower journal grooves (not shown) are formed in a herringbone shape at the lower portion of the inner circumferential surface of the sleeve 112 to form the lower journal bearing 132 of FIG. 4. The lower journal grooves are arranged at an uneven interval like the upper journal grooves 113.

A plurality of thrust grooves (not shown), which form the upper and lower thrust bearings 151 and 152 of FIG. 4 to support the shaft 120 in the axial direction, are formed in the inner circumferential surface of the sleeve 112 corresponding to the upper and lower surfaces of the thrust flange 140 of FIG. 4. The thrust grooves are formed in a herringbone shape and arranged at a constant interval. By forming the thrust grooves in the herringbone shape, a large load support capacity and stiffness in the axial direction of the shaft 120 can be obtained.

FIG. 10 is a graph showing the trajectory of the center of mass of each of the spindle motor A for a hard disk drive using a conventional journal bearing and the spindle motor B for a hard disk drive using a journal bearing according to the exemplary embodiment of the present invention illustrated in FIG. 9. The trajectory of the center of mass shown in FIG. 10 is a result of analyzing a kinematic equation of a rotation body considering the maximum mass unbalance which can be generated when a disk is actually installed on the spindle motor for a hard disk drive. A bearing force generating in the bearing is analyzed using a finite element method (FEM). Referring to FIG. 10, in the spindle motor B according to the exemplary embodiment of the present invention, the center of mass is moved eccentrically with respect to the origin compared to the conventional spindle motor A, due to the distribution of pressure in the bearing, so that eccentricity increases.

Table 1 shows a result of comparison of the static characteristics of the upper and lower journal bearings of the spindle motor for a hard disk drive according to the present invention illustrated in FIG. 9 and those of the conventional spindle motor for a hard disk drive.

TABLE 1

| | Conventional | | Spindle Motor According | |
|---|---|---|---|---|
| | Spindle Motor | | to the Present Invention | |
| | Upper | Lower | Upper | Lower |
| | Journal | Journal | Journal | Journal |
| 1000 rpm | Bearing | Bearing | Bearing | Bearing |
| Width of | 2.2 | 1.2 | 2.2 | 1.2 |
| Bearing (mm) | | | | |
| Eccentricity | 0.02 | 0.01 | 0.2 | 0.27 |
| Ratio | | | | |
| Load Support | 5.44E−01 | 8.77E−02 | 5.46E−01 | 1.40E−01 |
| Capacity (N) | | | | |
| Friction | 5.89E−04 | 3.22E−04 | 5.93E−04 | 3.33E−04 |
| Torque (Nm) | | | | |

Referring to Table 1, it can be seen that the eccentricity ratio of the spindle motor according to the present invention is greater than that of the conventional spindle motor. Although the friction torque of the upper and lower journal bearings of the spindle motor according to the present invention increases about 0.68%-3.4% compared to that of the upper low lower journal bearings of the conventional spindle motor, the increase is negligible.

Table 2 shows a result of calculation of stiffness and a damping coefficient of each of the upper and lower journal bearings of the spindle motor according to the present invention illustrated in FIG. 9 and those of the conventional spindle motor for a hard disk drive in a finite element method.

TABLE 2

| | | | Spindle Motor | |
|---|---|---|---|---|
| | Conventional | | According to the | |
| | Spindle Motor | | Present Invention | |
| | Upper | Lower | Upper | Lower |
| | Journal | Journal | Journal | Journal |
| 1000 rpm | Bearing | Bearing | Bearing | Bearing |
| Kₓₓ [N/m] | 6.16E+06 | 1.81E+06 | 7.93E+06 | 1.77E+06 |
| K_{xy} [N/m] | 6.87E+06 | 1.20E+06 | 1.10E+07 | 2.71E+06 |
| K_{yy} [N/m] | 6.16E+06 | 1.81E+06 | 5.99E+06 | 2.13E+06 |
| K_{θxθx} | 5.78E−01 | 5.75E−02 | 6.79E−01 | 6.40E−02 |
| [N/rad] | | | | |
| K_{θxθy} | 5.42E−01 | 3.16E−02 | 7.75E−01 | 4.99E−02 |
| [N/rad] | | | | |
| K_{θyθy} | 5.79E−01 | 5.75E−02 | 1.04E+00 | 7.42E−02 |
| [N/rad] | | | | |
| Cₓₓ [Ns/m] | 1.25E+04 | 2.31E+03 | 2.11E+04 | 5.54E+03 |
| C_{xy} [Ns/m] | 2.51E+00 | 2.54E−01 | −1.29E+04 | 7.73E+02 |
| C_{yy} [Ns/m] | 1.25E+04 | 2.31E+03 | 1.58E+04 | 3.61E+03 |
| C_{θxθx} | 1.09E−03 | 6.23E−05 | 1.35E−03 | 8.64E−05 |
| [Nms/rad] | | | | |
| C_{θxθy} | −3.04E−07 | −1.08E−08 | 1.32E−04 | −1.95E−05 |
| [Nms/rad] | | | | |
| C_{θyθy} | 1.09E−03 | 6.23E−05 | 1.78E−03 | 1.35E−04 |
| [Nms/rad] | | | | |

In Table 2, Kₓₓ, K_{xy}, K_{yy}, K_{θxθx}, K_{θxθy}, and K_{θyθy} indicate directional components of stiffness while Cₓₓ, C_{xy}, C_{yy}, C_{θxθx}, C_{θxθy}, and C_{θyθy} indicate directional components of the damping coefficient. Referring to Table 2, it can be seen that the stiffness of the journal bearing of the spindle motor according to the exemplary embodiment of the present invention is increased by about 10%-70% compared to that of the journal bearing of the conventional spindle motor. Also, the damping coefficient of the journal bearing of the spindle motor according to the exemplary embodiment of the present invention is increased by about 20%-140% compared to that of the journal bearing of the conventional spindle motor.

Table 3 shows a result of calculation of the natural frequency of a spindle motor for a hard disk drive in a finite element method using the stiffness and damping coefficient of the journal bearing calculated in Table 2.

TABLE 3

| | Natural Frequency (Hz) | |
|---|---|---|
| | Conventional | Spindle Motor according to |
| Mode | Spindle Motor | the Present Invention |
| Half Speed Whirl | 39.57 | 48.72 |
| Half Speed Whirl | 86.64 | 74.38 |
| First Motor Bending | 283.85 | 361.06 |
| Vibration | | |
| Second Motor Bending | 654.76 | 698.44 |
| Vibration | | |
| Disk Bending Vibration | 825.99 | 826.26 |

Referring to Table 3, it can be seen that the natural frequency in a motor bending mode greatly affected by the stiffness of the bearing is increased by about 27.2% and 6.67%.

Thus, in the spindle motor for a hard disk drive using a journal bearing according to the exemplary embodiment of the present invention the stiffness and the damping coefficient increase and accordingly the natural frequency increases, compared to those of the spindle motor for a hard disk drive using the conventional journal bearing. Thus, the reliability to resonance escape of the spindle motor according to the present invention can be improved compared to the conventional spindle motor.

As described above, according to the spindle motor for a hard disk drive according to the present invention, since the grooves are arranged at uneven interval on the outer circumferential surface of the shaft, the eccentricity ratio of the rotation body is increased so that the stiffness and the damping performance are improved. Thus, the rotational precision of the spindle motor is improved.

While this invention has been particularly shown and described with reference to exemplary embodiments thereof, it will be understood by those skilled in the art that various changes in form and details may be made therein without departing from the spirit and scope of the invention as defined by the appended claims.

1. A spindle motor comprising:
a base;
a sleeve fixed on the base, the sleeve comprising a hollow portion; and
a shaft rotatably installed in the hollow portion of the sleeve,
wherein a plurality of journal grooves are formed in an outer circumferential surface of the shaft to form a journal bearing which supports the shaft in a radial direction when the shaft rotates, and the journal grooves are arranged at an uneven interval.

2. The spindle motor as claimed in claim 1, wherein the journal grooves are formed in a herringbone shape.

3. The spindle motor as claimed in claim 1, further comprising a thrust flange having an outer diameter greater than that of the shaft and coupled to a lower end portion of the shaft.

4. The spindle motor as claimed in claim 3, wherein a plurality of thrust grooves are formed in each of upper and lower surfaces of the thrust flange to form a thrust bearing which supports the shaft in an axial direction when the shaft rotates.

5. The spindle motor as claimed in claim 4, wherein the thrust grooves are formed in a herringbone shape.

6. The spindle motor as claimed in claim 4, wherein the thrust grooves are arranged at a constant interval.

7. A spindle motor comprising:
a base;
a sleeve fixed on the base, the sleeve comprising a hollow portion; and
a shaft rotatably installed in the hollow portion of the sleeve,
wherein a plurality of upper and lower journal grooves are formed in upper and lower portions of an outer circumferential surface of the shaft to form upper and lower journal bearings which support the shaft in a radial direction when the shaft rotates, and the upper and lower journal grooves are arranged at an uneven interval.

8. The spindle motor as claimed in claim 7, wherein the upper and lower journal bearings are formed in a herringbone shape.

9. The spindle motor as claimed in claim 7, wherein lubricating fluid fills between the shaft and the sleeve.

10. The spindle motor as claimed in claim 9, wherein the lubricating fluid is air.

11. The spindle motor as claimed in claim 7, wherein the shaft is formed of ceramic.

12. The spindle motor as claimed in claim 7, wherein the sleeve is formed of ceramic.

13. The spindle motor as claimed in claim 7, further comprising a thrust flange having an outer diameter greater than that of the shaft and coupled to a lower end portion of the shaft.

14. The spindle motor as claimed in claim 13, wherein a plurality of thrust grooves are formed in each of upper and lower surfaces of the thrust flange to form a thrust bearing which supports the shaft in an axial direction when the shaft rotates.

15. The spindle motor as claimed in claim 14, wherein the thrust grooves are formed in a herringbone shape.

16. The spindle motor as claimed in claim 14, wherein the thrust grooves are arranged at a constant interval.

17. A spindle motor comprising:
a base;
a sleeve fixed on the base, the sleeve comprising a hollow portion; and
a shaft rotatably installed in the hollow portion of the sleeve,
wherein a plurality of journal grooves are formed in an inner circumferential surface of the sleeve corresponding to an outer circumferential surface of the shaft to form a journal bearing which supports the shaft in a radial direction when the shaft rotates, and the journal grooves are arranged at an uneven interval.

18. The spindle motor as claimed in claim 17, wherein the journal bearings are formed in a herringbone shape.

19. The spindle motor as claimed in claim 17, further comprising a thrust flange having an outer diameter greater than that of the shaft and coupled to a lower end portion of the shaft.

20. The spindle motor as claimed in claim 19, wherein a plurality of thrust grooves are formed in the inner circumferential surface of the sleeve corresponding to upper and lower surfaces of the thrust flange to form a thrust bearing which supports the shaft in an axial direction when the shaft rotates.

21. The spindle motor as claimed in claim 20, wherein the thrust grooves are formed in a herringbone shape.

22. The spindle motor as claimed in claim 20, wherein the thrust grooves are arranged at a constant interval.

23. A spindle motor comprising:
a base;
a sleeve fixed on the base, the sleeve comprising and having a hollow portion; and
a shaft rotatably installed in the hollow portion of the sleeve,
wherein a plurality of upper and lower journal grooves are formed in upper and lower portions of an inner circumferential surface of the sleeve corresponding to an outer circumferential surface of the shaft to form upper and lower journal bearings which support the shaft in a radial direction when the shaft rotates, and the upper and lower journal grooves are arranged at an uneven interval.

24. The spindle motor as claimed in claim 23, wherein the upper and lower journal bearings are formed in a herringbone shape.

25. The spindle motor as claimed in claim 23, further comprising a thrust flange having an outer diameter greater than that of the shaft and coupled to a lower end portion of the shaft.

26. The spindle motor as claimed in claim 25, wherein a plurality of thrust grooves are formed in the inner circumferential surface of the sleeve corresponding to upper and lower surfaces of the thrust flange to form a thrust bearing which supports the shaft in an axial direction when the shaft rotates.

27. The spindle motor as claimed in claim 26, wherein the thrust grooves are formed in a herringbone shape.

28. The spindle motor as claimed in claim 26, wherein the thrust grooves are arranged at a constant interval.
